(19) United States
(12) Patent Application Publication
(10) Pub. No.: US 2024/0232528 A9
(43) Pub. Date: Jul. 11, 2024

(54) PART OF SPEECH TAGGING WITH CONTEXT SENTENCES

(71) Applicant: INTERNATIONAL BUSINESS MACHINES CORPORATION, ARMONK, NY (US)

(72) Inventors: Masayasu Muraoka, Tokyo (JP); Dolca Tellols Asensi, Castelló (ES); Issei Yoshida, Tokyo (JP)

(21) Appl. No.: 18/048,626

(22) Filed: Oct. 21, 2022

(51) Int. Cl. G06F 40/253; G06F 40/117; G06F 40/279

(52) U.S. Cl. CPC G06F 40/253; G06F 40/117; G06F 40/279

(57) ABSTRACT

Computer technology for determining and tagging parts of speech in a text (that is PoS ragging), where the context used by the natural language processing machine logic (for example, NLP software) includes both: (i) other words in the sentence under analysis where a given word to be tagged appears; and (ii) words in the other sentences besides the sentence under analysis. Other context sentences may be selected randomly, by Next Sentence Prediction technology and/or by choosing sentences in textual proximity to the sentence under analysis.

### BACKGROUND

The present invention relates generally to the field of natural language processing, and more particularly to part of speech tagging models.

The Wikipedia entry for “Natural language processing” (as of Apr. 27, 2022) states as follows: “Natural language processing (NLP) is a subfield of linguistics, computer science, and artificial intelligence concerned with the interactions between computers and human language, in particular how to program computers to process and analyze large amounts of natural language data. The goal is a computer capable of ‘understanding’ the contents of documents, including the contextual nuances of the language within them. The technology can then accurately extract information and insights contained in the documents as well as categorize and organize the documents themselves.”

The Wikipedia entry for “Corpus linguistics” (as of Apr. 27, 2022) states as follows: “Corpus linguistics is the study of a language as that language is expressed in its text corpus (plural corpora), its body of ‘real world’ text. Corpus linguistics proposes that a reliable analysis of a language is more feasible with corpora collected in the field—the natural context (‘realia’) of that language—with minimal experimental interference.”

The Wikipedia entry for “Part-of-speech tagging” (as of Apr. 27, 2022) states as follows: “In corpus linguistics, part-of-speech tagging (POS tagging or PoS tagging or POST), also called grammatical tagging is the process of marking up a word in a text (corpus) as corresponding to a particular part of speech, based on both its definition and its context. A simplified form of this is commonly taught to school-age children, in the identification of words as nouns, verbs, adjectives, adverbs, etc. Once performed by hand, POS tagging is now done in the context of computational linguistics, using algorithms which associate discrete terms, as well as hidden parts of speech, by a set of descriptive tags. POS-tagging algorithms fall into two distinctive groups: rule-based and stochastic.” Various embodiments of the present invention, to be discussed below, typically use stochastic type PoS tagging.

### SUMMARY

According to an aspect of the present invention, there is a method, computer program product and/or system that performs the following operations (not necessarily in the following order): (i) receiving a corpus data set corresponding to a piece of natural language text including a plurality of sentences and an indication of the beginning and end of each sentence of the plurality of sentences; (ii) receiving an indication of a target sentence from the plurality of sentences of the piece of natural language text from the corpus data set; (iii) determining a plurality of taggable words included in the target sentence; (iv) determining a set of context sentence(s) for use in performing part of speech tagging on the target sentence with the context sentence(s) being determined based on the proximity of the context sentence(s) to the target sentence in the piece of natural language text of the corpus data set; and (v) for each given word of the plurality of taggable words of the target sentence, performing natural language processing to determine a part of speech tag for the given word based, at least in part, on the set of context sentences.

### BRIEF DESCRIPTION OF THE DRAWINGS

FIG. 1 is a block diagram view of a first embodiment of a system according to the present invention;

FIG. 2 is a block diagram showing a machine logic (for example, software) portion of the first embodiment system;

FIG. 3 is a flowchart showing a first embodiment of a method performed, at least in part, by the first embodiment system.

FIG. 4 is a screenshot view of a three sentence long corpus; and

FIG. 5 is a block diagram showing a PoS tagging scheme according to the present invention.

### DETAILED DESCRIPTION

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As shown in the first Figure of this document, computing environment 100 contains an example of an environment for the execution of at least some of the computer code involved in performing the inventive methods, such as natural language processing module 200 (also herein sometimes referred to as block 200). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing. In some embodiments of the present invention, processor set 110 includes a GPU (Graphical Processing Unit) and/or TPU (Tensor Processing Unit) in addition. Some embodiments of the present invention may use GPU(s) for faster computation. For example, in some embodiments of the present invention, a GPU is included in the processor set because it takes too much time to execute the invention in a manner relying exclusively on CPUs.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### II. Example Embodiment

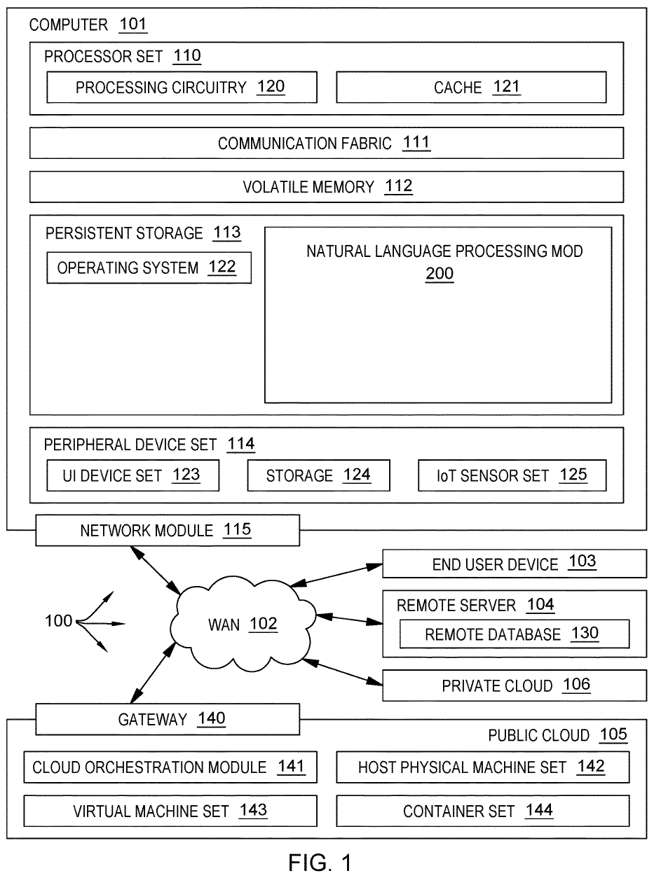

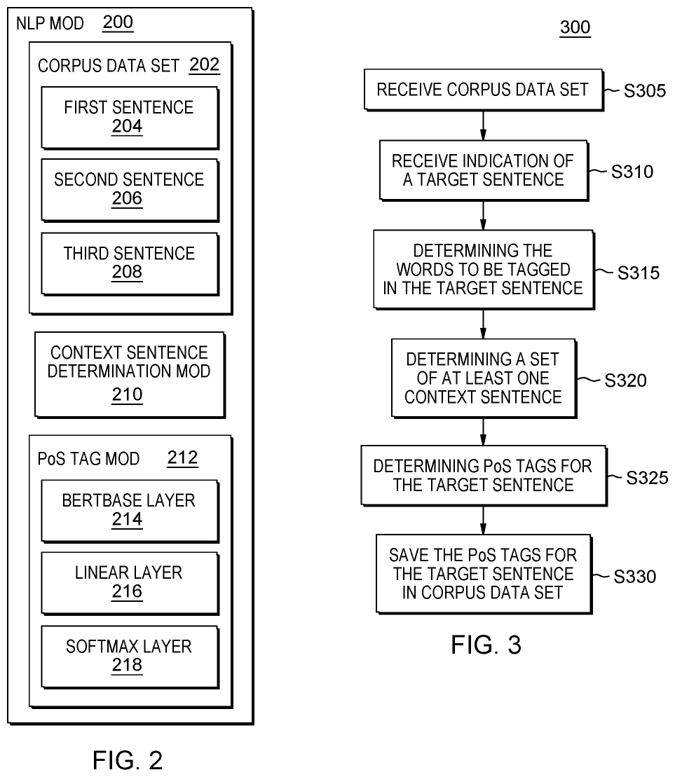

Computing environment 100 is an environment in which an example method according to the present invention can be performed. As shown in FIG. 3, flowchart 300 shows an example method according to the present invention. As shown in FIG. 2, NLP mod 200 performs or control performance of at least some of the method operations of flowchart 300. This method and associated software will now be discussed, over the course of the following paragraphs, with extensive reference to the blocks of FIGS. 1, 2 and 3. It is noted that the method of flowchart 300 deals with two different ways of choosing the context sentences. A third way of determining context sentences, called Next Sentence Prediction, will be explained and discussed in sub-section III of this Detailed Description section. As a preliminary result on terminology, “predicting PoS tags” and “determining PoS tags” are used interchangeably in this document—as will be appreciated by those of skill in the art, the determination of PoS tags by software and machine learning is subject to incorrect determinations, which is why it is sometimes referred to as prediction (typically subject to later verification)—however, the degree of certitude in the correctness of the tags is not particularly relevant to the present invention and will likely improve over time.

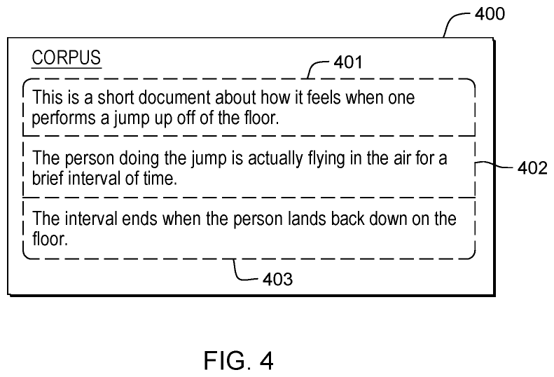

Processing begins at operation S305, where NLP module (“mod”) 200 receives corpus 202, including a first sentence 204 (see screen shot 400 of FIG. 4 at reference numeral 401); second sentence 206 (see screen shot 400 at reference numeral 402) and third sentence 208 (see screen shot 400 at reference numeral 403). While the corpus includes only three sentences (for the sake of simplicity and reader comprehension), most embodiments of the present invention will use a larger corpus with many more sentences.

Processing proceeds to operation S310, where NLP mod 200 receives an indication of a target sentence in the corpus, where the target sentence is a sentence that is to be subjected to part of speech (PoS) tagging in order to enrich the corpus to make it more useful for machine learning. In this simple example, the chosen target sentence is second sentence 206 (see reference numeral 402 for the text of this target sentence).

Processing proceeds to operation S315, where PoS tag mod 212 determines that the sixteen (16) words are to be tagged in the target sentence. In this simple example, the words in the target sentence are as follows: the, person, doing, the (second instance), jumping, is, actually, flying, in, the (third instance), air, for, a, brief, interval and time. This simple example does not tag punctuation marks, but, alternatively, other embodiments may subject symbols, such as periods, commas, ampersands and colons, to PoS tagging. In this simple example, the words are easy to immediately recognize as words. However, even in this simple example, the machine logic must be sophisticated enough to determine that the period at the end of the sentence is not included as part of the last word (that is, in this example, the word “time”). In other examples, the challenge of identifying the words may be more substantial. For example, the phrase “the land of the rising sun,” in some embodiments, might be recognized as a single word (in this case, a proper noun) that means “Japan.” Those of ordinary skill in the art will recognize that conventional NLP software is capable of breaking a sentence up into its constituent words—the specific computer techniques for doing this are outside the scope of the present invention. Words and/or short phrases identified as being eligible for part of speech identification are sometimes herein referred to as “taggable words.”

Processing proceeds to operation S320 where context sentence determination mod 210 determines the context sentences. In this simple example, there are only two possible context sentences to be chosen, specifically first sentence 204 and third sentence 208. It is noted that a corpus can be augmented, even during the NLP processing to be expanded and to include additional sentences (and perhaps better context sentences).

In this example of flow chart 300, the method used to determine the set of context sentence(s) is based on proximity in the text of the corpus to the target sentence. More specifically, in this example, mod 210 is programmed to choose the sentences immediately before and after the target sentence as the two context sentences. That means that mod 210 determines first sentence 204 and third sentence 208 to be the context sentences. As a variation, textual proximity may be only one factor considered. For example, the context sentence determination mod could be programmed to choose the sentence in the closest textual proximity that shares at least four (4) words (excluding common articles and prepositions) with the target sentence.

As an alternative or additional factor in context sentence determination, a random approach may be used. This approach is further discussed in the next sub-section of this Detailed Description section. The random approach may be combined with the textual proximity approach, which yields a process that is herein to be considered as both proximity-based and random-based. Sometimes the word “semi-random” may be used to describe an approach that has a random aspect, but also considers additional non-random sentences when determining the context sentence(s).

Processing proceeds to operation S325, where PoS tag mod 212 (including BERTBASE layer 214, linear layer 216 and softmax layer 218), for each given word of the plurality of taggable words of the target sentence, performs natural language processing to determine a part of speech tag for the given word based, at least in part, on the set of context sentences.

In this example, the word “interval” appears in the target sentence and in context sentence 208 (that is, third sentence 208, see the screenshot of FIG. 4 to see the word match between the target sentence and the context sentence). The word “interval” may be a noun, or it may be an adjective (as in the sentence, “Hiro performs interval training every day.”). To continue this example, the word “interval” is already PoS-tagged in the context sentence as a noun, so the instance of the word “interval” in the target sentence is assumed to be, and is PoS-tagged as, a noun and not tagged as an adjective in corpus data set 202. In this case a “similar word” (in this case the identical word) in the context sentence helps with PoS tagging, and/or tag prediction, in the target sentence.

Further in this example, the word “jump” appears in the target sentence and the word “jump” appears in context sentence 204 (that is, first sentence 204, see the screenshot of FIG. 4 to see the word match between the target sentence and the context sentence). The word “jump” may be a noun or a verb. To continue this further example, the word “jump” is PoS-tagged in context sentence 204 as a noun, so the PoS tag for “jump” in the target sentence is determined to be a noun as well.

Processing proceeds to operation S330, the PoS tags for the target sentence, previously determined at operation S325, are saved into corpus data set 202, as a prediction result, by PoS tag mod 212. For example, if the corpus is later expanded to include additional untagged sentences, then second sentence 206 may now serve as a context sentence in the next round of PoS tagging.

### III. Further Comments and/or Embodiments

Part of Speech (PoS) tagging is a fundamental task in Natural Language Processing (NLP). A PoS tagging model predicts the PoS tags for each word in an input sentence. Current PoS tagging tasks assume that an instance is composed of a sentence. A machine-learning-based, or ML-based, PoS tagging model is typically trained on a set of instances, which means that these currently conventional PoS tagging models do not get access to sentences other than a given sentence when being trained on the given sentence. For example, when analyzing a given sentence from a larger text, currently conventional PoS tagging models do not access preceding or following sentences of the text. In other words, currently conventional PoS tagging models have to predict the PoS tags only with the information obtained in the given sentence. However, some sentences have few, or no, clues to predict some PoS tags. For example, consider the following sentence: “I was thinking the one's at around 5.” This sentence is difficult to parse, or perhaps impossible, without reference to preceding parts of the text in which it is included. Humans often refer to the surrounding sentences to get more information when they see unfamiliar words or expressions in a sentence, but currently conventional PoS tagging models do not typically do this.

In some embodiments, a new training method is provided for PoS tagging tasks. This new training method adds “context sentences” to each instance to allow a PoS tagging model to have more information when determining a part of speech for each word and/or phrase in a sentence under analysis (herein sometimes referred to as a PoS-analysis instance or, more simply, an “instance”). Context sentences are added to at least some of the instances when doing PoS analysis. In some embodiments, the context sentences are extracted from the same corpus/domain on which a PoS tagging model is trained.

Some possible types of added context sentences that can be used in various embodiments of the present invention include the following types: (i) Adjacent Type where adjacent sentences in the original corpus are used in performing PoS tagging on a given instance; (ii) Next Sentence Prediction (NSP) Type where context sentences are collected to use with the given instance by performing Next Sentence Prediction classification using an NSP algorithm now known or to be developed in the future, for example, BERT and Devlin+'19 with BERT being trained to predict whether two given sentences are adjacent or not; (iii) Random Type where context sentences are sampled randomly, or semi-randomly from the original corpus and/or (iv) Contrastive type were context sentences are collected from the corpus based on having different PoS tags than the sentence under analysis (that is, the target sentence) does.

Potential extension can be represented mathematically as continuous feature vectors (for example, document embeddings) obtained from the corpus beforehand and applicable to other sentence-level tasks such as tokenization, named entity recognition, and sentiment analysis.

Some embodiments may use a BERT-based PoS tagger and a UD (Universal Dependencies) v2.6 EWT (English Web Treebank) corpus to train the PoS tagger model. Such an experimental setup can be tested for effectiveness by reporting an average F1 score (±Standard deviation) for 10 different runs on test set. Such a test may be used to quantify improved performance with respect to an analogous PoS tagging baseline method that does not use context sentences and checking for statistically significant (p<0.01) differences. If sentences extracted from other corpora/domains are utilized as context sentences, this can negatively affect PoS tagging performance.

Some embodiments use a training corpus that includes Universal Dependencies (UD, Nivre+'20 v2.6 English EWT). Some embodiments use XPOS (language specific tags) to provide the possible tag candidates for the context-aware PoS tagging of the present invention. In some embodiments, the PoS tagging architecture is a BERTBASE layer followed by a linear layer followed by a softmax layer. BERT is a language model that can encode input texts into feature vectors. The encoded feature vectors have shown to be effective in a number of NLP tasks [Devlin+'19]. Training settings may include the following parameters: Batch size; Optimization; Learning rate; and Number of epoch. UD provides several corpora in different domains such as: (a) EWT: (1) blog, (2) email, (3) reviews, and (4) social; (b) GUM: (1) academic, (2) blog, (3) fiction, (4) government, (5) news, (6) nonfiction, (7) social, (8) spoken, (9) web, and (10) wiki; (c) LinES: (1) fiction, (2) nonfiction, and (3) spoken, (d) ParTUT: (1) legal, (2) news, and (3) wiki; These corpora are used for collecting context sentences. Target corpus is fixed to EWT.

Some embodiments do not use an assumption that the input (that is, PoS tagger input) is a phase. Some embodiments do not assume any certain type of text. Some embodiments accept not only a phase, but rather, a whole sentence as input, and adopts the whole sentence as context (in addition to the other types of context sentences discussed above). Some embodiments do not require a manual workload to define artificial information to be used as context. Some embodiments include a newly proposed task formulation in which the input to the PoS tagger includes multiple sentences, which is to say that a context larger than a single sentence is used. Some embodiments can recognize sentences without sentence numbering, meaning that a corpus with numbered sentences is not required. Some embodiments use a corpus that does not include sentences adjacent to the target sentence, but these embodiments are likely to obtain sentences that are “semantically adjacent” to the target sentence. This can be done using a next sentence prediction classifier that is pre-trained in BERT. Some embodiments address a sentence level task (that is, a normal PoS tagging task) that does not require document level labels. To explain the term “semantically adjacent,” Semantically adjacent sentences are sentences that can be virtually connected to each other and convey a valid meaning without any contradiction while they do not appear in a corpus. For example, sentences 401 to 403 in FIG. 4 can be considered as semantically adjacent sentences because these sentences convey a valid meaning without any contradiction.

Some examples of PoS tags according to some embodiments of the present invention includes: ADJ: adjective; ADP: adposition (cover term for prepositions and postpositions); ADV: adverb; AUX: auxiliary; CCONJ: coordinating conjunction; DET: determiner; INTJ: interjection; NOUN: noun; NUM: numeral; PART: particle; PRON: pronoun; PROPN: proper noun; PUNCT: punctuation; SCONJ: subordinating conjunction; SYM: symbol; VERB: verb; and X: other.

According to some embodiments of the present invention, an example of PoS tagging will now be discussed. In this example, the target sentence Sₜ is the t-th sentence in the corpus and reads as follows: “I was thinking the one's at around 5.” Two example context sentences are as follows: (i) for Sₜ₋₁: “Do you know how much the item sold in the latter site is?”; and (ii) for Sₜ₊₁: “It's cheaper than the former.” A resulting set of PoS tags for the target sentence in this example is “PRON AUX VERB DET NOUN PART ADP ADV NUM PUNCT.” These PoS tags are mapped to the target sentence as follows: (i) the “I” in the target sentence is tagged with PRON for pronoun; (ii) the “was” in the target sentence is tagged with AUX for auxiliary; (iii) the “thinking” in the target sentence is tagged with VERB corresponding to a verb; (iv) the “the” in the target sentence is tagged with DET corresponding to a determiner; (v) the “one” of “one's” in the target sentence is tagged with NOUN corresponding to a noun; (vi) the “'s” of “one's” in the target sentence is tagged with PART corresponding to a particle; (vii) the “at” in the target sentence is tagged with ADP corresponding to an adposition; (viii) the “around” in the target sentence is tagged with ADV corresponding to an adverb; (ix) the “5” in the target sentence is tagged with NUM corresponding to a number; and (x) the “.” in the target sentence is tagged with PUNCT corresponding to a punctuation.

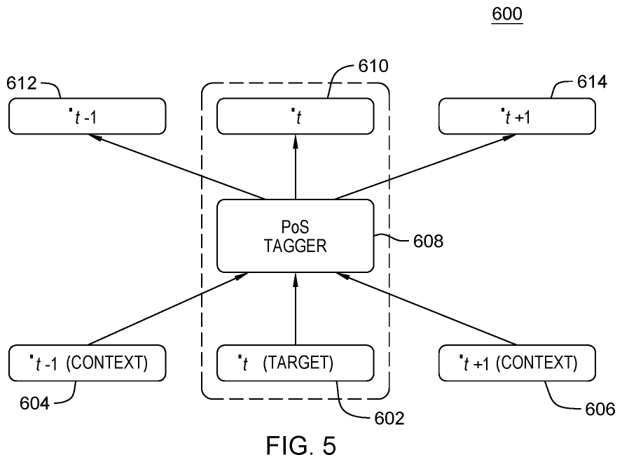

Shown in FIG. 5 is block diagram 600 illustrating an example PoS tagging process according to some embodiments of the present invention, including: PoS tagger 608; pre-tagged target sentence data block 602; post-tagged context sentence data block 610; pre-tagged context sentence data block 604; post-tagged context sentence data block 612; pre-tagged context sentence data block 606; and post-tagged context sentence data block 614. The context sentences are tagged at the same time the target sentence is tagged, but only the PoS tags of the target sentence are saved and the PoS tags of the context sentences are discarded at this time.

According to some embodiments of the present invention, there is a method, computer program product and/or system for training a model which performs a sentence-level task (for example, part-of-speech tagging model, tokenization model, named entity recognition model, and sentiment analysis model) that performs the following operations (not necessarily in the following order): (i) reading an input sentence from a corpus; (ii) extracting a context for the input sentence from the corpus/a same domain corpus, the context being a sentence; (iii) inputting the input sentence and the context into the model; and (iv) outputting what the model predicts as an output corresponding to the input sentence.

The method, computer program product and/or system of the previous paragraph may further include one, or more, of the following operations, features, characteristics and/or advantages: (i) wherein the extracting the context includes extracting, as the context, a sentence adjacent to the input sentence in the corpus; and (ii) wherein the extracting the context includes collecting from the corpus or the same domain corpus, as the context, a sentence that is determined to be a sentence adjacent to the input sentence by a next sentence prediction classifier.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

And/or: inclusive or; for example, A, B “and/or” C means that at least one of A or B or C is true and applicable.

In an Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, and application-specific integrated circuit (ASIC) based devices.

What is claimed is:

1. A computer-implemented method (CIM) comprising:
receiving a corpus data set corresponding to a piece of natural language text including a plurality of sentences and an indication of the beginning and end of each sentence of the plurality of sentences;
receiving an indication of a target sentence from the plurality of sentences of the piece of natural language text from the corpus data set;
determining a plurality of taggable words included in the target sentence;
determining a set of context sentence(s) for use in performing part of speech tagging on the target sentence with the context sentence(s) being determined based on the proximity of the context sentence(s) to the target sentence in the piece of natural language text of the corpus data set; and
for each given word of the plurality of taggable words of the target sentence, performing natural language processing to determine a part of speech tag for the given word based, at least in part, on the set of context sentences.

2. The CIM of claim 1, further comprising:
for each given word of the plurality of taggable words of the target sentence, saving the part of speech tag for the given word in the corpus data set.

3. The CIM of claim 2 wherein the performance of natural language processing to determine a part of speech tag for the given word based, at least in part, on the set of context sentences includes determining a part of speech tag for at least one word in each context sentence, the CIM further comprising:
discarding the part of speech tags determined for words in the context(s).

4. The CIM of claim 1 wherein the determination of the part of speech tag of the target sentence includes:
selecting a selected word of the target sentence for tagging; and
finding a similar word in the set of context sentence(s); and
tagging the selected word based, at least in part, on a part of speech tag assigned to the similar word.

5. The CIM of claim 1 wherein the determination the set of context sentence(s) includes:
obtaining a document embedding from the corpus data set, with the document embedding being applicable to at least one of the following sentence-level tasks: tokenization, named entity recognition and/or sentiment analysis; and
mathematically representing a potential extension as a continuous feature vector based on the document embedding.

6. The CIM of claim 1 wherein:
the training corpus includes Universal Dependencies;
the part of speech tags are derived from XPOS language specific tags; and
the natural language processing uses software that includes a BERTASE layer, a linear layer and a softmax layer.

7. A computer-implemented method (CIM) comprising:
receiving a corpus data set corresponding to a piece of natural language text including a plurality of sentences and an indication of the beginning and end of each sentence of the plurality of sentences;
receiving an indication of a target sentence from the plurality of sentences of the piece of natural language text from the corpus data set;
determining a plurality of taggable words included in the target sentence;
determining a set of context sentence(s) for use in performing part of speech tagging on the target sentence with the context sentence(s) being determined based on random selection of the context sentence(s) from the piece of natural language text of the corpus data set; and
for each given word of the plurality of taggable words of the target sentence, performing natural language processing to determine a part of speech tag for the given word based, at least in part, on the set of context sentences.

8. The CIM of claim 7 further comprising:
for each given word of the plurality of taggable words of the target sentence, saving the part of speech tag for the given word in the corpus data set.

9. The CIM of claim 8 wherein the performance of natural language processing to determine a part of speech tag for the given word based, at least in part, on the set of context sentences includes determining a part of speech tag for at least one word in each context sentence, the CIM further comprising:
discarding the part of speech tags determined for words in the context(s).

10. The CIM of claim 7 wherein the determination of the part of speech tag of the target sentence includes:
selecting a selected word of the target sentence for tagging; and
finding a similar word in the set of context sentence(s); and
tagging the selected word based, at least in part, on a part of speech tag assigned to the similar word.

11. The CIM of claim 7 wherein the determination the set of context sentence(s) includes
obtaining a document embedding from the corpus data set, with the document embedding being applicable to at least one of the following sentence-level tasks: tokenization, named entity recognition and/or sentiment analysis; and
mathematically representing a potential extension as a continuous feature vector based on the document embedding.

12. The CIM of claim 7 wherein:
the training corpus includes Universal Dependencies;
the part of speech tags are derived from XPOS language specific tags; and
the natural language processing uses software that includes a BERTASE layer, a linear layer and a softmax layer.

13. A computer-implemented method (CIM) comprising:
receiving a corpus data set corresponding to a piece of natural language text including a plurality of sentences and an indication of the beginning and end of each sentence of the plurality of sentences;
receiving an indication of a target sentence from the plurality of sentences of the piece of natural language text from the corpus data set;
determining a plurality of taggable words included in the target sentence;
determining a set of context sentence(s) for use in performing part of speech tagging on the target sentence with the context sentence(s) being determined based on performing Next Sentence Prediction processing using the target sentence and the piece of natural language text of the corpus data set; and
for each given word of the plurality of taggable words of the target sentence, performing natural language processing to determine a part of speech tag for the given word based, at least in part, on the set of context sentences.

14. The CIM of claim 13 further comprising:
for each given word of the plurality of taggable words of the target sentence, saving the part of speech tag for the given word in the corpus data set.

15. The CIM of claim 14 wherein the performance of natural language processing to determine a part of speech tag for the given word based, at least in part, on the set of context sentences includes determining a part of speech tag for at least one word in each context sentence, the CIM further comprising:
discarding the part of speech tags determined for words in the context(s).

16. The CIM of claim 13 wherein the determination of the part of speech tag of the target sentence includes:
selecting a selected word of the target sentence for tagging; and
finding a similar word in the set of context sentence(s); and
tagging the selected word based, at least in part, on a part of speech tag assigned to the similar word.

17. The CIM of claim 13 wherein the determination the set of context sentence(s) includes: obtaining a document embedding from the corpus data set, with the document embedding being applicable to at least one of the following sentence-level tasks:
tokenization, named entity recognition and/or sentiment analysis; and
mathematically representing a potential extension as a continuous feature vector based on the document embedding.

18. The CIM of claim 13 wherein:
the training corpus includes Universal Dependencies;
the part of speech tags are derived from XPOS language specific tags; and
the natural language processing uses software that includes a BERTASE layer, a linear layer and a softmax layer.
